(19) United States
(12) Patent Application Publication
(10) Pub. No.: US 2010/0177183 A1
(43) Pub. Date: Jul. 15, 2010

(54) Personal Hygiene Inspection Device and Method

(76) Inventor: George Patterson Bellis, SR., Erath, LA (US)

Correspondence Address: GEORGE PATTERSON BELLIS SR., 619 NORTH SEVERIN STREET, ERATH, LA, 70533, US

(21) Appl. No.: 12/351,874

(22) Filed: Jan. 12, 2009

(51) Int. Cl. H04N 7/18

(52) U.S. Cl. 348/77; 348/E07.085

(57) ABSTRACT

An electronic device utilized for personal inspection of areas of the body that cannot be viewed in detail utilizing mirrors. Back light and focus capabilities of the device allow for clear concise viewing of hard to view areas. A measurement component further provides a means to repeat views of a certain area accurately, and the ability to monitor changes in size of a lesion. When connected to a common desktop or laptop computer these areas can be closely inspected and recorded for comparison with future inspections by creating digital images of the area in question. Changes in size or color of moles and other common lesions can be monitored for possible association with skin cancers. The digital images can be transmitted electronically to your health care provider for a diagnosis or recommendation. This method will blend well with the current trend toward outpatient services and home health care.

### BACKGROUND OF THE INVENTION

1. Field of the Invention

The invention relates to devices and methods for personal inspection of hard to view areas of the human body, and more particularly to a method of viewing, recording, and comparing snapshots of lesions to previous snapshots of lesions to denote changes in size and color therein. The present invention further relates to a method of transmitting this data to a healthcare professional for diagnosis.

2. General Background of the Invention

Advances in medical technology and the ability to diagnose conditions in an early stage of development, have made personal hygiene inspections a routine part of our lives. Self inspection of a lesion in the small of a person's back is very difficult using mirrors and leaves only the individuals memory to decide if it has changed in size or color. When a change is noted, the individual must make an appointment to see a doctor and all associated concessions including loss of time and wages, and possible exposure to other persons with contagious conditions. The current state of the art in digital imaging and computer technology, combined with advances in medical technology and the trend toward outpatient services and home health care, has prompted the development of the apparatus and method of the current invention.

### BRIEF SUMMARY OF THE INVENTION

The apparatus and method of the present invention solves this problem in a simple and straight forward manner. What is provided is a high resolution digital color camera surrounded by high intensity led lights that offer an adjustable illumination of the area directly in front of the camera lens. There is further provided a measuring component that allows repeatability of the distance of the camera lens from a particular area of the body, allowing the size of a lesion to be monitored and trended. The camera, light, and measuring assembly is attached to a flexible portion of a tripod stand, allowing positioning of the camera, light, and measuring assembly to be directed at any area of an average persons entire height, head to feet. There is further provided an electronic cable extending from a non-flexible portion of the tripod stand for connection to a common desktop or laptop computer that provides the functionality of the apparatus of the current invention.

Therefore it is a principle object of the current invention to provide individuals a means to view portions of their body that would otherwise be very difficult with mirrors or handheld photographic devices.

It is a further object of the current invention to provide an attached measuring device to allow consistent views of the same area to establish a trend of growth of a lesion.

It is a further object of the current invention to provide an adjustable high intensity led back light that can be adjusted to accommodate different areas of the body, and set to a specific intensity for re-examination of a particular area to establish a trend as mentioned above.

It is a further object of the current invention to provide a high resolution camera wherein images can be associated with the distance of the lens from the body as provided by the attached measuring device mentioned above, allowing for the calculation of a size legend for the image.

It is a further object of the current invention to provide a free standing apparatus that allows viewing of any portion of the body head to toe.

It is a further object of the current invention to provide a means to connect the apparatus to a common desktop or laptop computer for viewing, recording, and transmitting the data collected.

It is a further object of the current invention to provide a method wherein a high resolution, adequately lighted, measured distance, digital image of a particular area of the body can be transmitted to a health care provider as a prerequisite to a doctor visit.

It is a further object of the current invention to provide a means wherein a health care provider can determine if a lesion warrants a visit, at a lesser charge, saving the individual some expense and possible exposure to other persons having contagious viral or influenza conditions.

### BRIEF DESCRIPTION OF THE DRAWINGS

For a further understanding of the nature, objects, and advantages of the present invention, references should be had to the following detailed description, read in conjunction with the following drawings, wherein like reference numerals denote like elements and wherein:

FIG. 1 comprises a side elevation of the apparatus in use by an individual viewing a concerning lesion of their lower back. The apparatus is connected to a laptop computer on a tabletop and depicts a view of said lesion.

FIG. 2 comprises a side elevation of the apparatus in partial cross section and illustrates the path of the electronic control cable that connects the camera, light, and measurement assembly to the common Laptop or Desktop computer.

FIG. 3 comprises a side elevation of the flexible tubular portion of the apparatus with the camera, light, and measurement assembly attached.

FIG. 4 comprises a side elevation of the camera, light, and measurement assembly having greater detail of the molded extrusion of the camera and light housing that retains the measurement rod component of the camera, light, and measurement assembly.

FIG. 5 comprises a top elevation of the camera, light, and measurement assembly having greater detail of the molded extrusion of the camera and light housing that retains the measurement rod component of the camera, light, and measurement assembly.

FIG. 6 comprises a general elevation of the connector used to connect the apparatus to a common desktop or laptop computer.

FIG. 7 comprises a depiction of a health care provider evaluating a digital image electronically transmitted to him by the concerned individual depicted in FIG. 1.

### DETAILED DESCRIPTION OF THE INVENTION

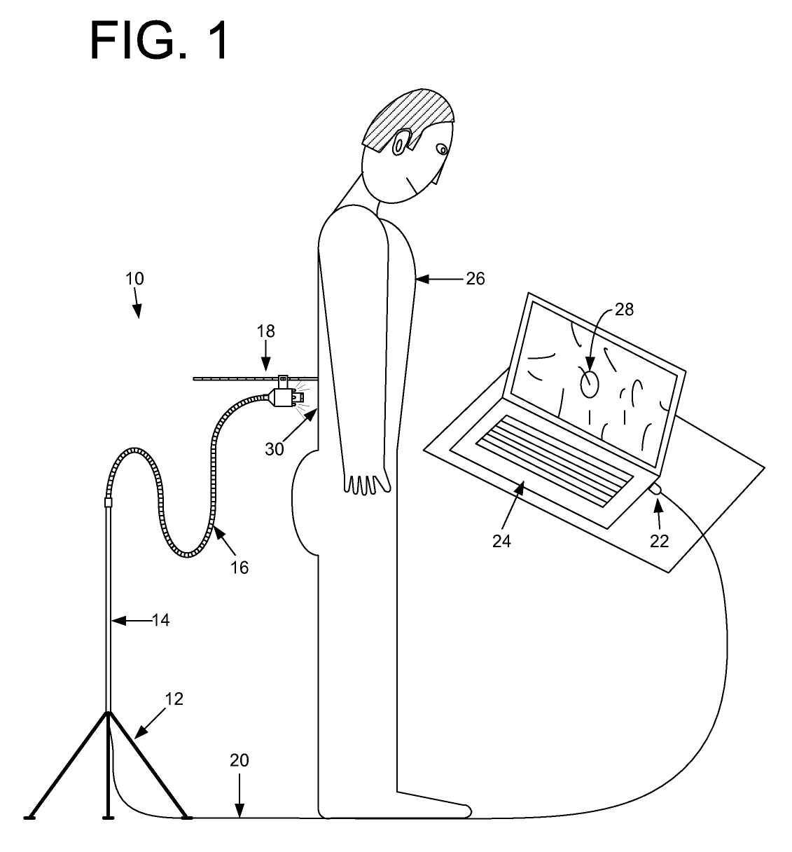

FIGS. 1-7 illustrate the preferred embodiment of the apparatus of the present invention referenced by the numeral 10.

As illustrated initially in FIG. 1 the Personal Hygiene Inspection Device 10 comprises a tripod base 12 supporting a generally elongated tubular component 14. A flexible tubular component 16 is attached to the top of the generally elongated tubular component 14, providing a mounting point for the camera, light, and measurement assembly 18. An electronic cable component 20 passes guidingly through generally elongated tubular component 14 and through flexible tubular component 16 and connects to the camera, light, and measurement assembly 18. The opposite end of electronic cable component 20 is fitted with an electronic connector 22 for connection to a computer 24. FIG. 1 further depicts an individual 26 viewing a digital image of a concerning lesion 28 on the computer 24, captured by camera, light, and measurement assembly 18, from the lower back area 30.

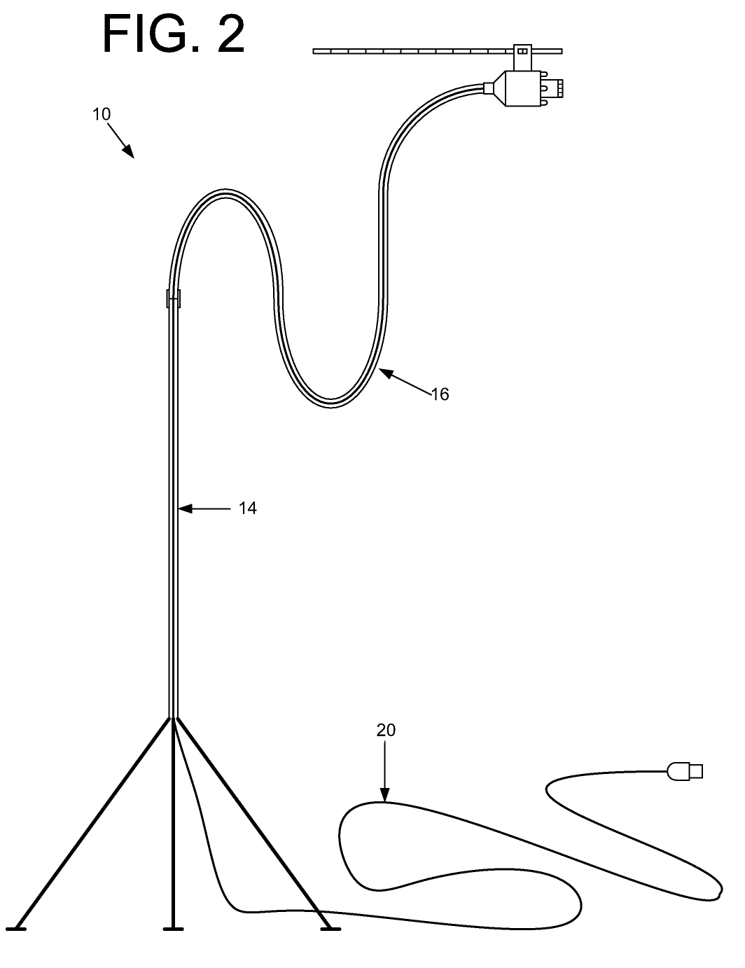

FIG. 2 comprises an enlarged side elevation in partial cross section of the preferred embodiment 10 having greater detail of the connections between generally elongated tubular component 14 and flexible tubular component 16. The guided passage of electronic cable component 20 through generally elongated tubular component 14 and flexible tubular component 16 can also be had in greater detail in the figure.

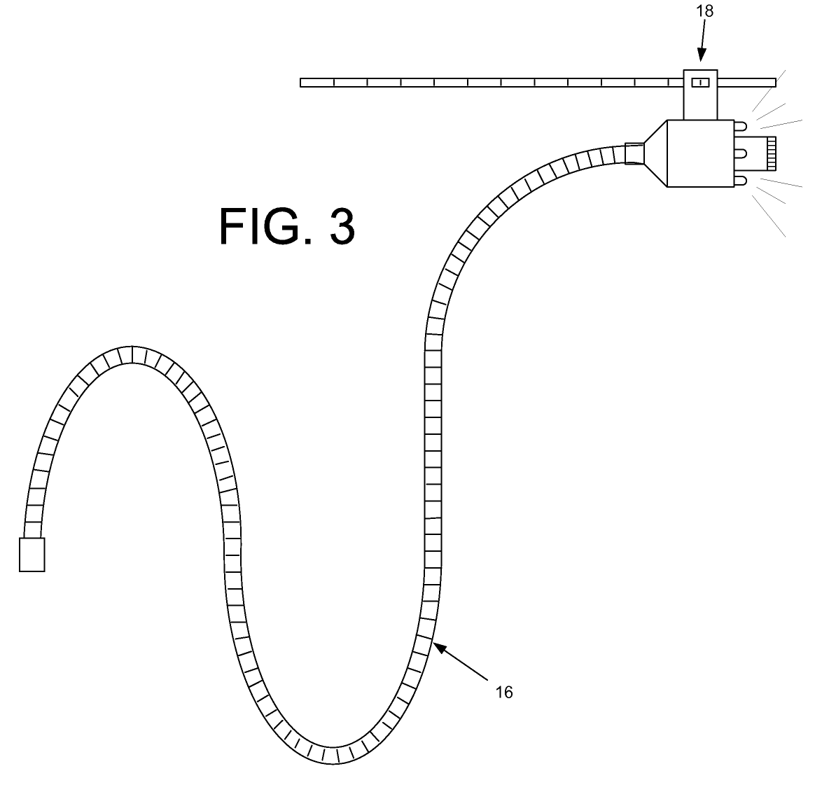

FIG. 3 comprises an enlarged side elevation of flexible tubular component 16 with camera, light, and measurement assembly 18 attached.

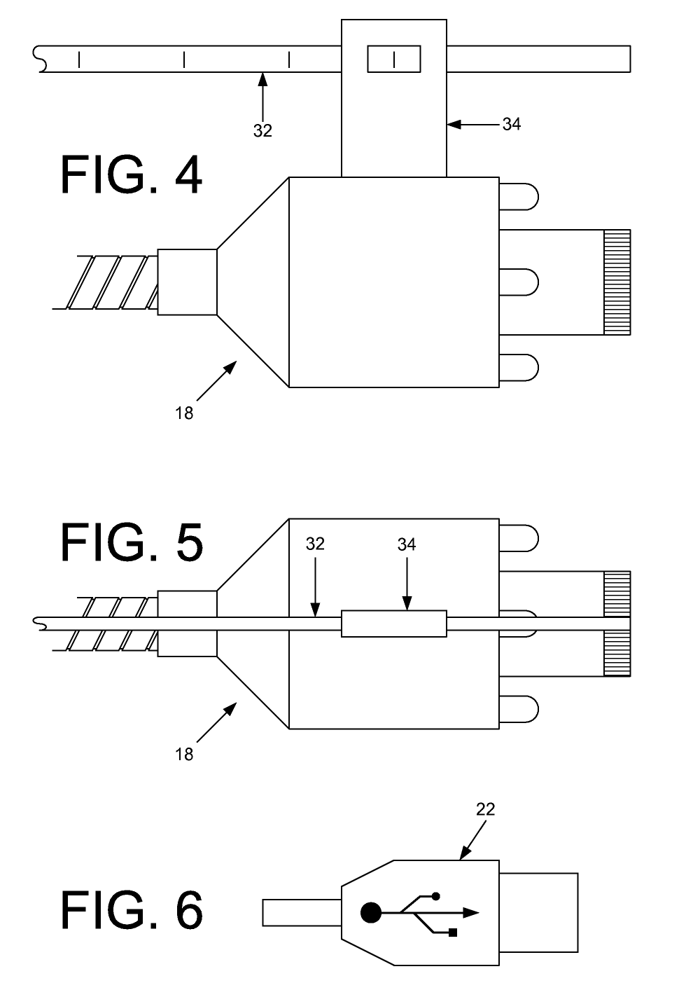

FIG. 4 comprises a side elevation of camera, light, and measurement assembly 18 having greater detail of the measurement bar 32 which passes guidingly through a molded extrusion 34 on camera, light, and measurement assembly 18.

FIG. 5 comprises a top elevation of camera, light, and measurement assembly 18 having greater detail of the measurement bar 32 which passes guidingly through molded extrusion 34 of camera, light, and measurement assembly 18.

FIG. 6 comprises an enlarged elevation of the electronic connector 22 used to connect the personal hygiene inspection device to a desktop or laptop computer.

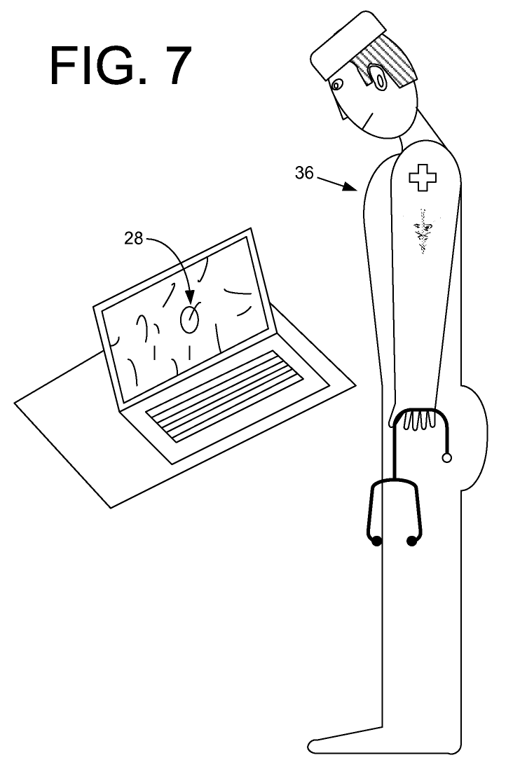

FIG. 7 depicts a health care professional 36 evaluating a digital image of a concerning lesion 28 transmitted electronically to the health care professional 36 by the individual depicted in FIG. 1.

What is claimed is:

1. A personal hygiene inspection apparatus comprising:
a. A tripod element for support of all other elements of the apparatus;
b. A generally elongated tubular element extending upward from the tripod element;
c. A flexible tubular element connected to the top of the generally elongated tubular element;
d. A camera, light, and measurement assembly attached to the end of the flexible tubular element.

2. The apparatus in claim 1, wherein the tripod element of the personal hygiene inspection apparatus provides complete support for the apparatus.

3. The apparatus in claim 1, wherein the combined height of the tripod element and the generally elongated tubular element is approximately waist high to an average person.

4. The apparatus in claim 1, wherein the flexible tubular element is sized to allow the attached camera, light, and measurement assembly to be positioned horizontally on the surface that the tripod element is resting on.

5. The apparatus in claim 1, wherein the flexibly tubular element is rigid enough to support the camera, light, and measurement assembly in any position from the horizontal positioning on the surface that the tripod element is resting on to an equal distance above the connection point of the flexible tubular element to the generally elongated tubular element.

6. The apparatus in claim 1, wherein the personal hygiene inspection apparatus is rigid enough to support the camera, light, and measurement assembly in a manner that will insure quality graphic imagery.

7. The apparatus in claim 1, wherein user intervention is not required to maintain a position of the camera, light, and measurement assembly after the desired positioning is achieved.

8. A personal hygiene inspection apparatus comprising;
a. A high resolution digital color camera as part of the camera, light, and measurement assembly;
b. An arrangement of high intensity led lights attached to the camera element of the camera, light, and measurement assembly;
c. A measurement element passing guidingly through an extrusion of the camera, light and measurement element housing for that purpose.

9. The apparatus in claim 8, wherein the high resolution digital color camera is positioned at a specific distance from a lesion or area to allow measurement of said lesion or area.

10. The apparatus in claim 8, wherein the high resolution digital color camera is capable of supporting software that can measure, record, and trend a lesion or area of a person's body.

11. The apparatus in claim 8, wherein an arrangement of high intensity led lights support high resolution digital color photography to record a life like image.

12. The apparatus in claim 8, wherein an arrangement of high intensity led lights are capable of supporting software that adjusts the intensity of the led bulbs for photographic purposes.

13. The apparatus in claim 8, wherein a measurement element is passed guidingly through an extrusion of the camera, light, and measurement assembly housing providing a measured distance of the lens of the camera element to the lesion or area being inspected.

14. The apparatus in claim 8, wherein the combination of the distance of the lens of the camera element to the lesion or area being inspected, combined with the resolution data of the digital image, can be utilized to calculate the size of said lesion or area being inspected.

15. A personal hygiene inspection apparatus comprising;
a. An electronic cable passing guidingly through the generally elongated tubular element and flexible tubular element;
b. An electronic connector attached to the opposite end of the electronic cable.

16. The apparatus in claim 15, wherein the electronic cable connecting the apparatus to the desktop or laptop computer provides the means for power and control of all elements of the personal hygiene inspection apparatus.

17. The apparatus in claim 15, wherein the electronic cable and the electronic cable connector are capable of supporting modern high resolution digital camera speed and power requirements.

18. The apparatus in claim 15, wherein all elements of the personal hygiene inspection device are capable of supporting software designed for the collection of digital images.

19. The apparatus in claim 15, wherein all elements of the personal hygiene inspection device are capable of supporting software that will ultimately develop from the use of the personal hygiene inspection device, further optimizing the data trending aspect of the technology of the present invention.

20. The apparatus in claim 15, wherein all elements of the personal hygiene inspection device and the computer interface provided will provide a means for doctors to interface with patients in a more efficient manner on external bodily issues that can be monitored and transmitted to a health care provider electronically.
